(19) United States
(12) Patent Application Publication
(10) Pub. No.: US 2001/0028391 A1
(43) Pub. Date: Oct. 11, 2001

(54) Digital camera for microscope and microscopic system provided with said camera

(76) Inventor: Chikaya Iko, Yokohama-shi (JP)

Correspondence Address: STAAS & HALSEY LLP, 700 11TH STREET, NW, SUITE 500, WASHINGTON, DC, 20001, US

(21) Appl. No.: 09/803,936

(22) Filed: Mar. 13, 2001

(30) Foreign Application Priority Data
Mar. 29, 2000 (JP) 2000-091685

(51) Int. Cl. H04N 5/253

(52) U.S. Cl. 348/110

(57) ABSTRACT

A digital camera is used with a microscope which comprises an objective lens system with a variable observing magnification and an illumination optical system provided at a predetermined position with respect to the objective lens system for illuminating an object to be observed. The camera comprises a correction unit for correcting a photographed image of the object to be observed in accordance with image correction data corresponding to each predetermined observing magnification of the objective lens system.

This application claims the benefit of Japanese Patent application No. 2000-091685 which is hereby incorporated by reference.

### BACKGROUND OF THE INVENTION

1. Field of the Invention

The present invention relates to a digital camera for a microscope and a microscopic system provided with such camera.

2. Related Background Art

Conventionally, when an imaging optical system itself, such as a lens attached to a camera, has such characteristics which cause inconveniences to photographing, including reduction of an amount of the ambient light of an optical image and an optical strain, the image is processed in accordance with an experimental correction value or an actual measurement value, whereby the image deterioration caused by the above characteristics is corrected. In this case, the characteristics such as a distortion and uneven illuminance are differentiated for each of different plural lenses or for each of the observing magnifications of the single lens.

For this reason, in case of a microscope which employs an objective lens with a variable observing magnification, for example, in case of a microscope which uses a plurality of objective lenses having different focal lengths selectively switched over or a microscope which uses a zooming type objective lens, the distortion and a state of the unevenness of illuminance are different for each observing magnification. More specifically, in case of the microscope which uses a plurality of different objective lenses which are selectively switched over, a state of the distortion, or the like, is different for each objective lens, while in case of the microscope which uses the zooming type objective lens, a state of the distortion, or the like, is different for each observing magnification. For this reason, it is difficult to conduct full correction for all of the objective lenses or all of the observing magnifications.

There are also cases in which the image data of the background of an object to be observed has an unevenness (non-uniformity) of brightness and unevenness of color. In addition to the characteristics of each lens, this unevenness of brightness, and the like are factors which may cause deterioration of a photographed image, so that it is desirable to remove them. Further, when a method of microscopic observation (such as a bright field observation method, a dark field observation method, a differential interference method, a phase contrast observation method, or a fluorescence observation method) is changed, the background image data is also changed. In this case, the aberration characteristics, unevenness of illuminance, and the like, which are inherent in each lens or in each observing magnification can be considered as systematic errors, while unevenness of brightness, and the like, included in the background image data as random errors.

### SUMMARY OF THE INVENTION

The present invention has been contrived taking the above problems into consideration, and an object thereof is to provide a digital camera which is used for a microscope provided with an objective lens system with a variable observing magnification and which can execute a correction processing for removing the systematic errors or the random errors mentioned above in order to obtain an optimal image for each objective lens, for each observing magnification and, further, for each microscopic observation system, as well as a microscopic system provided with such camera.

In order to solve the above problems, according to a first invention of the present application, there is provided a digital camera to be used with a microscope which comprises an objective lens system with a variable observing magnification and an illumination optical system provided at a predetermined position with respect to the objective lens system for illuminating an object to be observed, and which is characterized by further comprising a correction unit for correcting a photographed image of the object to be observed in accordance with image correction data corresponding to each predetermined observing magnification of the objective lens system. In this case, the objective lens system with a variable observing magnification is an objective lens system in which a plurality of objective lenses having different focal lengths are selectively switched over or an objective lens system in which the focal length is variable according to the zooming scheme.

According to a preferred embodiment of the first invention, the image correction data preferably is a photographing image data of a standard background image when the object to be observed is not present, and preferably contains the above photographing image data corresponding to the microscopic observation method of the microscope.

Also, according to a preferred embodiment of the first invention, it is preferable for the camera to further comprise an objective lens recognition unit for inputting the information for specifying the objective lens system with the predetermined observing magnification. In this case, the information for specifying the objective lens system with the predetermined observing magnification is the information for specifying the selected objective lens in case of the objective lens system with the plurality of different objective lenses to be selectively switched over, or the information for specifying the focal length state (the observing magnification), in case of the objective lens system of the zooming type, of this lens system.

Also according to a preferred embodiment of the first invention, the image correction data preferably contains at least one of illuminance distribution non-uniformity data, color unevenness data, and geometric aberration data of the image field.

Also, according to a second invention of the present application, there is provided a microscopic system which comprises a microscopic unit having an objective lens system with a variable observing magnification, and an illumination optical system provided at a predetermined position with respect to the objective lens system for illuminating an object to be observed, and a digital camera for a microscope according to the first invention.

### BRIEF DESCRIPTION OF THE DRAWINGS

FIG. 1 is a view for showing the structure of a microscopic system according to a first embodiment of the present invention;

FIG. 2 is a view for showing the structure of a signal processing unit between a camera head and an interface board;

FIGS. 3A to 3D are views for showing various image examples;

FIGS. 4A and 4B are a system drawing and a flow chart for showing a correction sequence, respectively; and

FIGS. 5A to 5C are views for showing characteristics inherent in objective lenses.

### DESCRIPTION OF THE PREFERRED EMBODIMENTS

Description will be made below on a digital camera for a microscope according to an embodiment of the present invention with reference to the attached drawings.

(First Embodiment)

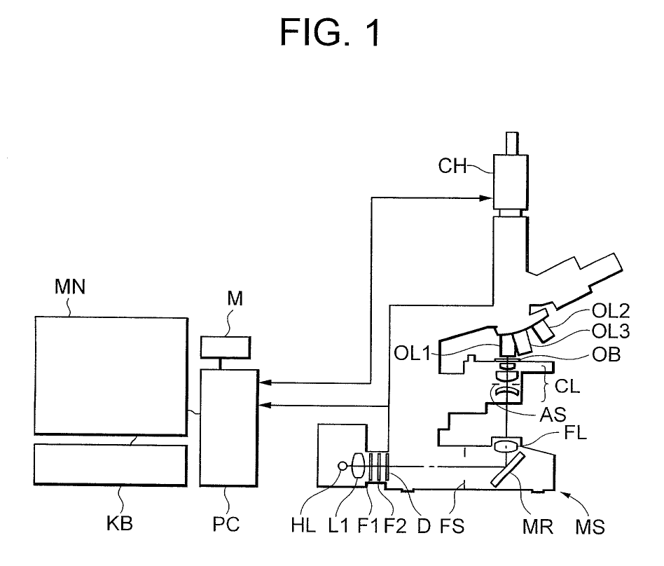

FIG. 1 is a view for showing the structure of a microscopic system with a digital camera for a microscope attached to the main body unit of the microscope, according to a first embodiment of the present invention. First, the main body unit MS of the microscope will be described. A light from a halogen lamp HL is passed through a collector lens L1 and an adiabatic filter F1 and then through a filter F2 to become an almost completely white light. Next, the light is passed through a diffusion plate D, and the view field of the light is restricted by a field stop FS. After that, an optical path of the light is bent substantially by 90 degrees by a reflection mirror MR. Then, the light is passed through a field lens FL to form an image by a condenser lens CL. Further, the light is passed through an aperture stop AS at which the brightness thereof is restricted, so as to illuminate an object (specimen) OB, and is also passed through an objective lens OL1. Then, the light goes through an unrepresented lens mount prism which is provided on the side of the observer of the objective lens OL1, and through an eyepiece, so as to observe the object image.

A camera head CH for taking in the object image is detachably attached to the top of the microscopic main body MS. The camera head CH is connected to a computer PC via an interface board. The computer PC is used to control a photographing operation of the camera head CH in accordance with a predetermined program. The microscopic main body MS is also connected to the computer PC.

A plurality of objective lenses OL1, OL2 and OL3 provided on a revolver can be selectively switched over. The information for specifying the selected objective lens is detected by an unrepresented sensor and is sent to the computer PC.

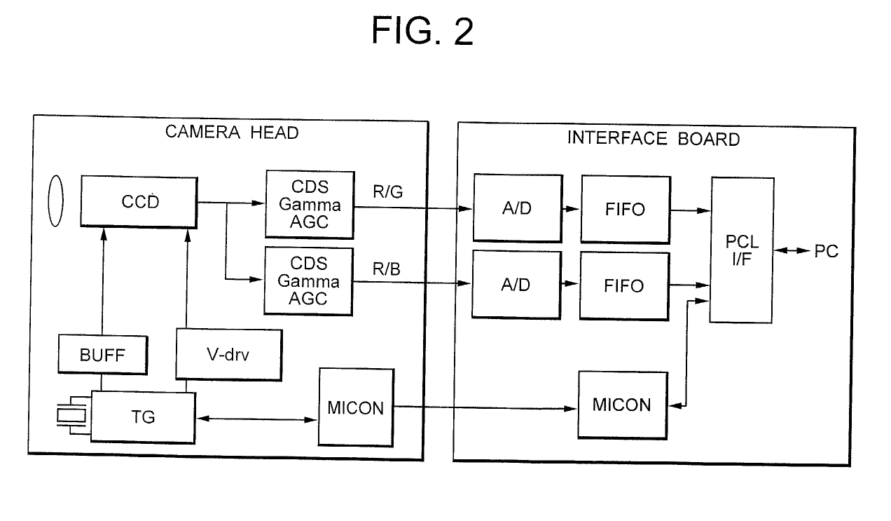

FIG. 2 is a view for showing the inner blocks of the camera head CH and the interface board. The image information taken in by an image pick-up device CCD is passed through a signal circuit for conducting automatic gain adjustment, etc., and is converted from an analog signal into a digital signal by an A/D conversion circuit. Next, the thus obtained signals are rearranged in a primary memory FIFO and are sent to the computer PC via a computer interface. On the other hand, the interface board and the camera head CH respectively have their own microcomputers MICONs. In addition, a signal created by a timing generator TG is sent to the image pick-up device CCD via a buffer BUFF or a V-drv which creates a driving signal in the vertical direction.

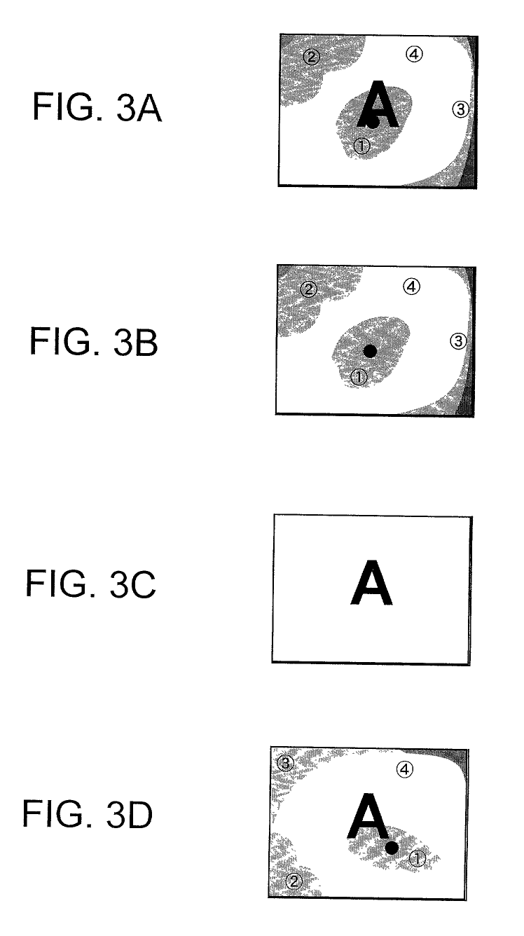

Next, a sequence for removing unevenness of illuminance, and the like, of the background image will be described. FIG. 3A shows a photographed image of the character “A” which is an object. The background of the object “A” contains unevenness of brightness and unevenness of color which are indicated by the numerals \mathring{1}, \mathring{2}, \mathring{3} and \mathring{4}. FIG. 3B shows the photographed image of a background with no object present. FIG. 3C shows a photographed image undergoing a correction processing which is described later. Further, FIG. 3D shows another background image which is photographed by using a different objective lens from that used in photographing the image in FIG. 3A. As clearly seen from comparison between the images in FIG. 3A and FIG. 3D, an error of the background image and an error inherent in the objective lens overlap each other to have different distributions of unevenness of brightness, and the like.

A sequence for removing an error of a background image will be described below more specifically. First, an original standard background color (brightness) is determined. For example, when the image is monochromatic and has 8-bit gradation, the maximum value of 255 gradations is set as the standard background color for a white background. Next, an exclusive OR operation is executed for each of the picture elements corresponding to the image in FIG. 3A and FIG. 3B. If the result is “true”, the picture elements are set at 255. If the result is “false”, the current value is maintained as it is.

More specifically, when the picture element of the object image is Sij, the picture element of the background image (the picture element of the image with no object present) is Bij, and the standard background value is Cw, respectively, the following conditions are satisfied:

$$if \vert Sij - Bij \vert = 0 , Sij = Cw , and$$

$$if \vert Sij - Bij \vert \neq 0 , Sij = Sij .$$

In the above conditions, i and j are integers for indicating respectively row and column of picture element. In this case, the object “A” is the only portion to become “false” in FIG. 3A and FIG. 3B, so that the image in FIG. 3C can be obtained when the above-mentioned OR operation is executed for all of the picture elements in the screen.

Logically, the background in this case is complete white. However, there is a possibility that a certain noise remains if there is a small difference in image phototaking conditions, and the like, between FIG. 3A and FIG. 3B. If there is such possibility, it is preferable to provide a margin for determining whether the result of the operation of the picture elements is true or false. For example, it is preferable to set a specific range in such a manner that, when the brightness of a specific picture element in FIG. 3A is 50, the result is assumed to be true if the value of the picture element in FIG. 2B corresponding to the above specific picture element is 50±5. In this manner, it is possible to eliminate the influence of a slight error of the picture element at the same background position in two photographing operations, that is, for photographing the background image and for photographing only the scene with the object.

Also, in order to obtain a natural image state, it is more preferable to add, not only the judgement on whether the result of the exclusive OR operation for the picture elements is true or false, but also a difference between the picture elements, than to obtain the completely uniform background image. After the specific range a is provided in the judgement and the result is judged as being within the range a and true, the difference with respect to the image in FIG. 3B is subtracted from the standard background value. In this case, if the standard background value takes a value which has a little allowance added to the maximum gradation, this difference can reflect the result in either the positive direction or the negative direction. More specifically, if the allowed range for the difference with the background image is set at a, the following conditions are satisfied:

$$if \vert Sij - Bij \vert ≦ α , Sij = Cw + ( Sij - Bij ) , and$$

$$if \vert Sij - Bij \vert > α , Sij = Sij .$$

With such calculation processing, it is possible to obtain a natural image state.

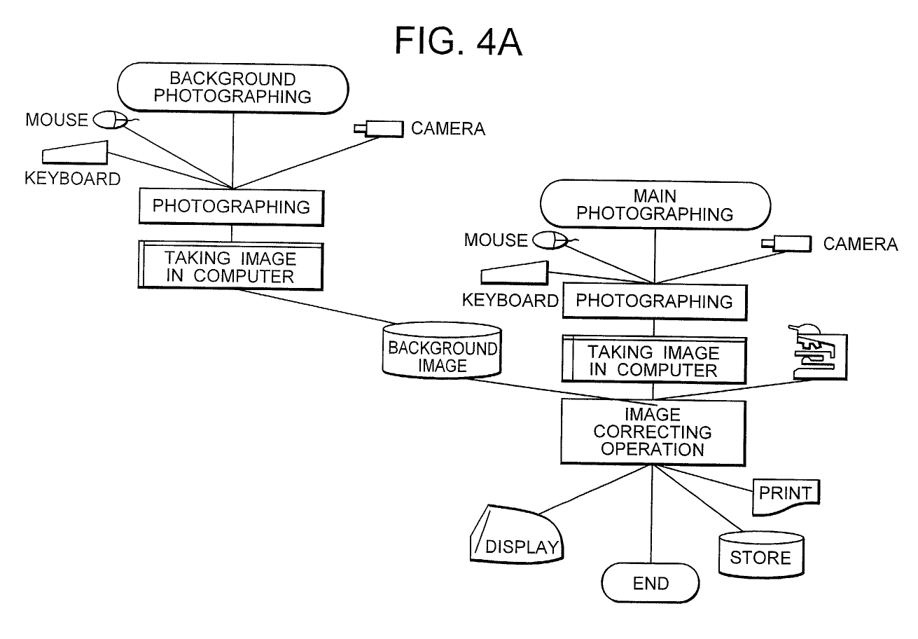

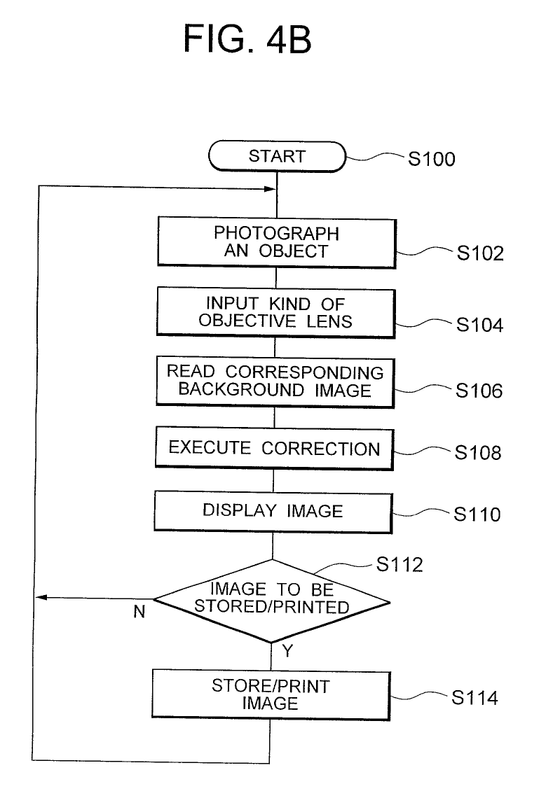

FIG. 4A is a conceptual view for showing the sequence described above. Only the background image is photographed in advance for each objective lens by using a keyboard or a mouse, and then is stored in a memory medium. Next, the main photographing operation for photographing an object is conducted in the same sequence as that for recording the background image, so that the photographed image is taken in a computer, or the like. After that, as a processing by the computer, in accordance with the kind of an objective lens which is used in the photographing and input from the microscope main body, the background image data corresponding thereto is read out of the memory unit. Such data is correction-processed in accordance with the above algorithm, and the result thereof is displayed, printed, or stored.

This sequence will be described with reference to the flow chart in FIG. 4B. First, it is assumed that the background image has been already photographed and stored. A series of processings are started in step 100. In step 102, a lens with a desired magnification is selected out of a plurality of objective lenses, and an object disposed at a predetermined position is photographed at a proper magnification. The kind of the objective lens which is used in the photographing in step 104 is input in the computer. In this case, it is possible to specify the kind of the selected objective lens when the observer recognizes the objective lens on the basis of the objective lens information detected by the microscope main body and inputs this recognized information by the use of the keyboard. When the microscope main body is to detect the kind of the objective lens, a position sensor or a rotational angle sensor, for example, is disposed around the circumference of the revolver on which a plurality of objective lenses are provided. Then, the rotational angle of the revolver and the kind of the objective lens are determined in advance, and the corresponding relation therebetween is stored in a table. When the observer rotates the revolver to select either one of the objective lenses, this sensor detects the rotational angle of the revolver, so as to determine the kind of the objective lens with reference to the table.

Next, in step 106, the computer calls the background image corresponding to the objective lens in use. Then, the computer executes a series of correction processings which are described above in step 108. In step 110, the corrected image is displayed on the monitor. In step 112, it is judged whether the corrected image is to be stored or printed. Consequently, when the printing or storing operation is to be executed, a printing operation by a printer or storage into a hard disc is executed. When the printing operation, or the like, is not to be executed, the program returns to step 102, to start a series of steps from the photographing of the object.

Though the foregoing embodiment was described by using a monochromatic image, the same processing can be conducted with respect to the three colors of R (red), G (green) and B (blue) in case of a color image.

(Second Embodiment)

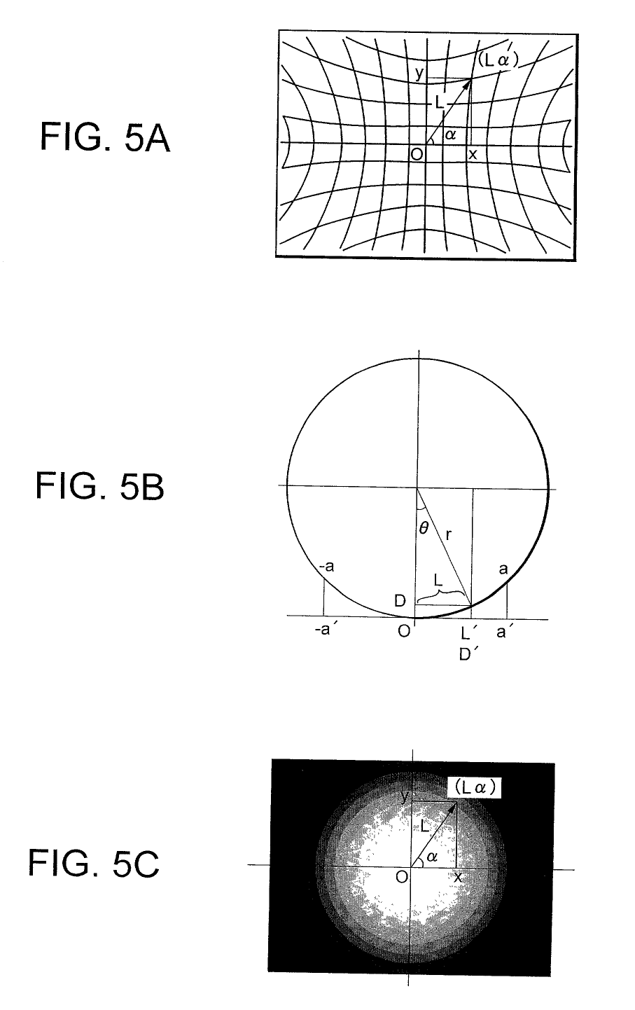

A second embodiment of the present invention will be described with reference to FIGS. 5A to 5C. In the second embodiment, the characteristics inherent in an objective lens, such as a distortion and a reduced ambient illuminance, are to be corrected. The structure of the used apparatus is the same as that in the first embodiment described above, so that description thereof will be omitted.

FIG. 5A is a view for showing a photographed image when a positive pin cushion distortion is generated in photographing a square grid. A pin cushion distortion is an error with a magnification which increases in proportion to the distance from the center of the optical axis. Note that, an error with a magnification which decreases in proportion to the distance from the center of the optical axis is called a barrel distortion. Such distortions can be treated as numerical parameters corresponding to the degrees of the distortions even when the whole of the image pattern is not used as correction data as it is.

An arbitrary orthogonal coordinates (x, y) are transformed into polar coordinates (L, α) by the use of the function L=(x²+y²)½, α=arc tan(y/x). This image distortion can be considered as a spherical projection image having the radius r which is in contact with a flat plane at the origin O, as shown in FIG. 5B.

If the degree of a distortion of the image in the range from −a to a is represented by r, r is a positive finite numerical value, and the solid angle θ of the coordinates (L, α) satisfies the conditions:

θ=L/r (0<θ<π/2), and

sin θ=L/r (θ=0).

Consequently, L′=r sin θ(0<θ<π/2).

In the above-described manner, −a . . . a can be transformed into −a′ . . . a′. Then, from the condition: X′=L′ cos α, y′=L′ sin α, the coordinates can be returned to the orthogonal coordinate system.

FIG. 5C shows an example of a reduced ambient illuminance which is so-called a shading. The shading is a phenomenon that the brightness is decreased in proportion to the distance from the center of the optical axis. Like the geometric aberrations such as a distortion described above, the shading can be specified by means of several kinds of parameters. That is, after the parameters are transformed into polar coordinates, the density deviation of the image which is indicated by the coordinate D on the ordinate is extended onto the flat plane of −a′ . . . a in FIG. 5C, by using the above conditions of transformation. In this case, since the density is proportional to the empty weight, the condition of transformation is as follows:

D′=D/(cos² θ).

When the characteristics such as a distortion or a reduced ambient illuminance inherent in an objective lens are already known as described above, it is possible to execute the image correction in accordance with the information for specifying an objective lens to be used in a photographing operation, in the same manner as that of the above first embodiment.

In each of the foregoing embodiments, description was made on the microscope in which a plurality of objective lenses having different focal lengths are selectively switched over to be used. However, an image can be corrected in the same manner as in the foregoing embodiments in accordance with the following sequence even in case of the microscope which uses an objective lens system with a variable focal length by the zooming method. First, the objective lens of the zooming type has an encoder. This encoder outputs a signal corresponding to an angle of rotation of a zoom ring. The encoder signal is passed through the microscope main body MS and then is received by the computer PC. Then, the computer PC determines the focal length state of the zooming type objective lens, or an observing magnification, on the basis of the signal from the encoder. Also, the computer PC calculates a distortion or the degree of reduction of the ambient illuminance at an arbitrary observing magnification in accordance with the designed lens data by the sequence using the numerical parameters which are described in the above second embodiment. The computer PC then executes the image correction as described above.

In the above embodiment, description was made on the correction of an error caused by the aberration characteristics inherent in an objective lens, assuming that the microscopic observation method is the same. However, the present invention is not limited to this. It is clear that the present invention can be applied to a case in which the characteristics of the aberrations are changed when an incident angle of a light on the objective lens by changing the microscopic observation method (the bright field observation method, the dark field observation method, the differential interference method, the phase contrast observation method, and the fluorescence observation method).

As described above, according to the present invention, it is possible to provide a digital camera which is used for a microscope and provided with an objective lens with a variable observing magnification and which can execute a correction processing for removing a systematic error or a random error in order to obtain an optimal image for an objective lens, for each observing magnification, and for each microscopic observation method, as well as a microscopic system which is provided with such camera.

What is claimed is:

1. A digital camera for a microscope which comprises an objective lens system with a variable observing magnification and an illumination optical system provided at a predetermined position with respect to said objective lens system for illuminating an object to be observed, characterized in that:
said camera comprises a correction unit for correcting a photographed image of said object to be observed in accordance with image correction data corresponding to each predetermined observing magnification of said objective lens system.

2. A digital camera for a microscope according to claim 1, wherein said image correction data is photographing image data of a standard background image when said object to be observed is not present and contains said photographing image data according to the microscopic observation method of said microscope.

3. A digital camera for a microscope according to claim 1 or 2, further comprising an objective lens recognition unit for inputting the information for specifying a predetermined observing magnification of said objective lens.

4. A digital camera for a microscope according to claim 2, wherein said image correction data contains at least one of illuminance distribution non-uniformity data, color unevenness data, and geometric aberration data of the image field.

5. A microscopic system comprising:
a microscopic unit having an objective lens system with a variable observing magnification, and an illumination optical system provided at a predetermined position with respect to said objective lens system for illuminating an object to be observed; and
a digital camera for a microscope as set forth in claim 1.
